(19) United States
(12) Patent Application Publication
(10) Pub. No.: US 2013/0055987 A1
(43) Pub. Date: Mar. 7, 2013

(54) INTERNAL COMBUSTION RECIPROCATING PISTON ENGINE AND METHOD OF OPERATING THE SAME

(71) Applicant: Friedrich WIRZ, Haselau (DE)

(72) Inventor: Friedrich WIRZ, Haselau (DE)

(73) Assignee: MAN Diesel & Turbo SE, Augsburg (DE)

(21) Appl. No.: 13/598,991

(22) Filed: Aug. 30, 2012

(30) Foreign Application Priority Data
Sep. 2, 2011 (DE) 10 2011 082 039.6

(51) Int. Cl. F02M 43/00; F02D 19/10

(52) U.S. Cl. 123/304

(57) ABSTRACT

Internal combustion reciprocating piston engine and method for operating an internal combustion reciprocating piston engine which works according to the Diesel process and has at least one cylinder (10) in which is arranged a reciprocating piston (12) connected to a crankshaft (11), an air supply device (21) for providing combustion air in the cylinder, and a fuel injection arrangement (30) for injecting an LPG fuel from an LPG fuel reservoir (40) and a diesel fuel from a diesel fuel reservoir (50), wherein the method comprises: providing combustion air and compressing this combustion air in the cylinder, and injecting diesel fuel and LPG fuel by means of the fuel injection arrangement into the compressed combustion air in the cylinder, wherein prior to the injection of diesel fuel and LPG fuel the diesel fuel is mixed with the LPG fuel by means of the fuel mixing device (60) so that a homogeneous fuel emulsion of LPG fuel and diesel fuel is produced, and the fuel emulsion is subsequently injected into the at least one cylinder.

### FIELD OF THE INVENTION

The invention is directed to an internal combustion reciprocating piston engine which is constructed for providing driving energy using the Diesel process and to a method of operating an internal combustion reciprocating piston engine working according to the Diesel process.

### BACKGROUND OF THE INVENTION

An internal combustion reciprocating piston engine and a method of the type mentioned above are known from DE 603 17 482 T2.

Possible constructional variants of an internal combustion reciprocating piston engine for operation with LPG (Liquefied Petroleum Gas, also called Autogas or Campinggas in the German-speaking world) as fuel will be described in the following. LPG is a mixture of propane (C₃H₈) and butane (C₄H₁₀) as main constituents. The internal combustion reciprocating piston engine is constructed, e.g., as a four-stroke large-capacity engine.

Internal combustion reciprocating piston engines can vary according to the method of operation. The most common operating methods are the Diesel process and the Otto process. The Diesel process is characterized by an internal mixture formation (injection of fuel at top dead center after completion of the compression stroke) and auto-ignition of the fuel due to the high temperature of the combustion air at the end of the compression stroke). In contrast, the Otto process is characterized by an external mixture formation (in a central carburetor or individually in the suction pipes of the cylinders) and by an externally supplied ignition (through spark plugs or the like sources of ignition). Designs having internal mixture formation are also found in Otto engines (“direct injectors”) but, in contrast to the Diesel process, this takes place during the compression stroke.

Another important difference consists in the choice of the compression ratio. The efficiency is favorably affected in both operating methods by a higher compression ratio. However, a compression ratio increase in an Otto engine is limited in that the phenomenon known as “knocking” can occur in operation. Knocking occurs at high pressures and temperatures at the start of ignition and results from an excessively fast rise in pressure in the cylinder during the ignition process, which rise in pressure exerts a heavy additional thermal and mechanical load on the component parts of the combustion chamber. Apart from the compression ratio and the thermal conditions at the moment of ignition, the tendency toward knocking largely depends upon the fuel selected; the knocking behavior of the fuel is represented by the octane number. Diesel engines generally require a higher compression ratio than Otto engines in order to ensure that the temperature at completion of compression is sufficiently high for the fuel to self-ignite.

The following characteristics as they relate to the specific method are important for determining whether or not and by what method a fuel is capable of combustion in an engine. For combustion in Otto-type engines, a fuel should be resistant to knocking (thermally stable, high octane number) and have the lowest possible boiling temperature range. For combustion in diesel engines on the other hand, a fuel should be as ignitable as possible (low ignition temperature, high cetane number) and, further, should possess good lubricating properties (the latter for purely technical reasons because injection is carried out under high pressures and the lubrication of the injection components is very important).

Gasoline mainly comprises aromatic hydrocarbons which favorably meet the desired criteria of an Otto-type engine. In contrast, diesel fuel is a mixture of long-chain saturated hydrocarbons (paraffins) which favorably meet the desired criteria for combustion in a diesel engine.

Compared to gasoline, a mixture of propane and butane (hereinafter: PG) has a greater resistance to knocking and is therefore very well suited, especially in the gaseous phase occupied by the mixture in ambient conditions, to combustion in Otto-type engines designed for burning gasoline. This is the practice, for example, in the automotive field, where conventional gasoline engines are outfitted with an evaporation unit and are therefore capable of operating with LPG.

Modern large-capacity engines such as are used, for example, for power plant applications and ship's propulsion applications are usually diesel engines. Gas can also be burned according to the Otto process in these large-capacity engines by installing an external mixture formation device (e.g., intake manifold injection) and a spark ignition system (spark plug ignition or pilot oil ignition through injection of a diesel ignition jet). However, the compression ratios of these large-capacity engines are so high that a knock-free Otto-type operation with PG cannot be achieved. Rather, the compression ratio would have to be reduced to values customary for the Otto process; however, this would reduce the power density and efficiency of the large-capacity engines and would therefore rule out economical operation.

Alternatively, the PG can be burned according to the Diesel process in that by following the principle of internal mixture formation it is injected in liquid form (i.e., as LPG) and under high pressure at top dead center (TDC) after the compression stroke (ignition TDC). But LPG is not sufficiently combustible to ignite at the final compression temperature in the cylinder so that a complete diesel process can also not be embodied. An externally supplied ignition can be provided, however, in order to counter this. Therefore, the operating method corresponds to a combination of the Otto-type and Diesel engine methods in which the type of mixture formation corresponds to the Diesel process and the type of ignition corresponds to the Otto process.

### SUMMARY OF THE INVENTION

It is an object of the invention to provide an internal combustion reciprocating piston engine which can be operated without externally supplied ignition with LPG as fuel. The invention has the further object of providing a method by which the internal combustion reciprocating piston engine can be operated without externally supplied ignition with LPG as fuel.

According to a first aspect of the invention, an internal combustion reciprocating piston engine is provided for supplying drive energy using the Diesel process having: at least one cylinder in which is arranged a reciprocating piston connected to a crankshaft; an air supply device for providing combustion air to be compressed by the reciprocating piston in the cylinder; and a fuel injection arrangement for injecting in compressed combustion air in the cylinder an LPG fuel from an LPG fuel reservoir and a diesel fuel from a diesel fuel reservoir. The internal combustion reciprocating piston engine according to the invention is characterized in that a fuel mixing device is provided which is fluidically connected to the LPG fuel reservoir as well as to the diesel fuel reservoir and which produces a homogeneous fuel emulsion from LPG fuel and diesel fuel, wherein the fuel injection arrangement is fluidically connected to the fuel mixing device for injecting the fuel emulsion into the at least one cylinder.

According to an embodiment of the internal combustion reciprocating piston engine according to the invention, to produce the homogeneous fuel emulsion, the fuel mixing device is constructed to mix into an LPG fuel volume flow whose magnitude is dependent upon an operating condition of the internal combustion reciprocating piston engine a diesel fuel volume flow whose magnitude is smaller in relation to that of the LPG fuel volume flow.

The operating condition of the internal combustion reciprocating piston engine can be characterized, e.g., by a load condition, ambient conditions such as temperature and air humidity, etc.

According to a further embodiment of the internal combustion reciprocating piston engine according to the invention, the fuel mixing device is constructed such that the magnitude of the diesel fuel volume flow is less than 25 percent of the magnitude of the LPG fuel volume flow. The magnitude of the diesel fuel volume flow is preferably in a range of 1 to 15 percent, particularly in a range from 5 to 10 percent, of the magnitude of the LPG fuel volume flow.

According to yet another embodiment of the internal combustion reciprocating piston engine according to the invention, the fuel mixing device varies the magnitude of the diesel fuel volume flow in proportion to the magnitude of the LPG fuel volume flow depending on the operating condition (such as, e.g., the load condition) of the internal combustion reciprocating piston engine to ensure a combustibility of the fuel emulsion sufficient for the respective operating condition with a minimum proportion of diesel fuel in the fuel emulsion.

According to yet another embodiment of the internal combustion reciprocating piston engine according to the invention, the latter is a large-capacity four-stroke engine such as is used, e.g., for power plant applications and ship's propulsion applications.

According to a second aspect of the invention, a method is provided for operating an internal combustion reciprocating piston engine working according to the Diesel process which has at least one cylinder in which is arranged a reciprocating piston connected to a crankshaft, an air supply device for providing combustion air in the cylinder, and a fuel injection arrangement for injecting an LPG fuel from an LPG fuel reservoir and a diesel fuel from a diesel fuel reservoir. According to the invention, the method includes: providing combustion air and compressing this combustion air in the cylinder, injecting diesel fuel by means of the fuel injection arrangement into the compressed combustion air in the cylinder, injecting LPG fuel by means of the fuel injection arrangement into the compressed combustion air in the cylinder. The method according to the invention is characterized in that prior to the injection of diesel fuel and LPG fuel the diesel fuel is mixed with the LPG fuel by means of a fuel mixing device so that a homogeneous fuel emulsion of LPG fuel and diesel fuel is produced, and the fuel emulsion is subsequently injected into the at least one cylinder.

According to an embodiment of the method according to the invention, the homogeneous fuel emulsion is produced by mixing into an LPG fuel volume flow whose magnitude is dependent upon an operating condition of the internal combustion reciprocating piston engine a diesel fuel volume flow whose magnitude is smaller in relation to that of the LPG fuel volume flow.

According to a further embodiment of the method according to the invention, the homogeneous fuel emulsion is produced in such a way that the magnitude of the diesel fuel volume flow is less than 25 percent of the magnitude of the LPG fuel volume flow. The homogeneous fuel emulsion is preferably produced in such a way that the magnitude of the diesel fuel volume flow is in a range of 1 to 15 percent, particularly in a range of 5 to 10 percent, of the magnitude of the LPG fuel volume flow.

According to yet another embodiment of the method according to the invention, the magnitude of the diesel fuel volume flow is varied in proportion to the magnitude of the LPG fuel volume flow depending on the operating condition (such as, e.g., the load condition) of the internal combustion reciprocating piston engine in order to ensure a combustibility of the fuel emulsion sufficient for the respective operating condition with a minimum proportion of diesel fuel in the fuel emulsion.

Finally, it was recognized by the inventors that it would be advantageous for the combustion of PG and LPG to come as close as possible to the Diesel process and to circumvent the need for externally supplied ignition. To this end, it is suggested according to an embodiment of the invention to homogeneously mix a small amount of diesel fuel into the LPG fuel before injecting into the cylinder and to subsequently inject the fuel emulsion. The proportion of diesel fuel gives the fuel emulsion the desired auto-ignition characteristics which are lacking in the LPG fuel by itself. The homogeneous mixing of the two proportions ensures that the fuel emulsion behaves exactly like a pure diesel fuel with respect to the ignition behavior and combustion process, which could not be achieved by an externally supplied ignition (regardless of whether spark or ignition jet is used) due to the local ignition source and lack of simultaneity between injection and ignition.

The invention also expressly extends to embodiments not resulting from combinations of features from explicit back-referencing of claims and, accordingly, the disclosed features of the invention may be combined with one another in any technically useful manner.

### BRIEF DESCRIPTION OF THE DRAWINGS

The invention will be described in the following with reference to preferred embodiments and to the accompanying drawing.

FIG. 1 is a schematic view of an internal combustion reciprocating piston engine according to an embodiment of the invention.

### DETAILED DESCRIPTION OF THE PRESENTLY PREFERRED EMBODIMENTS

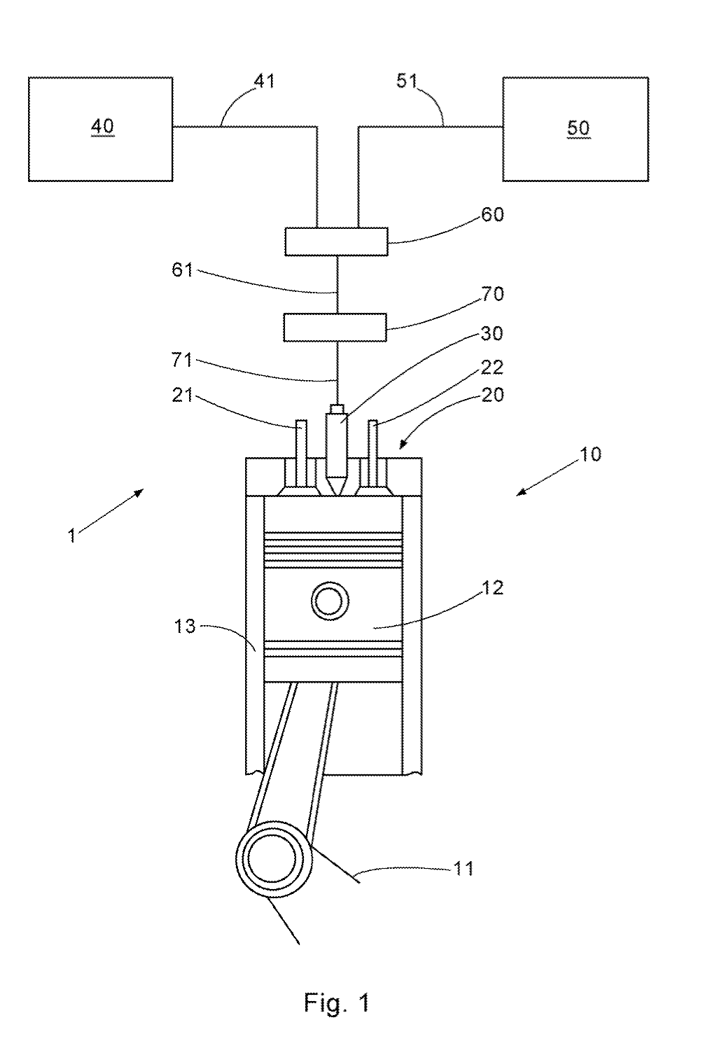

As is shown in FIG. 1, an internal combustion reciprocating piston engine 1 which works according to the Diesel process has, according to the invention, at least one cylinder 10 in which a reciprocating piston 12 connected to a crankshaft 11 is arranged so as to be displaceable in a liner sleeve 13, an air exchange arrangement 20, a fuel injection arrangement 30, an LPG fuel reservoir 40 (e.g., an LPG tank or LPG pressurized vessel), a diesel fuel reservoir 50 (e.g., a diesel tank), a fuel mixing device 60 and, if necessary, a high-pressure fuel pump 70.

The air exchange arrangement 20 has an air supply device 21 (e.g., in the form of an air inlet valve) for providing combustion air to be compressed by the reciprocating piston 12 in the cylinder 10 and an outlet device 22 (e.g., in the form of an air outlet valve) for allowing exhaust gases to escape from the cylinder 10. The air supply device 21 and the air outlet device 22 are actuated or opened and closed, respectively, by a camshaft (not shown), for example.

The fuel injection arrangement 30 is constructed to inject an LPG fuel from the LPG fuel reservoir 40 and a diesel fuel from the diesel fuel reservoir 50 in compressed combustion air in the cylinder 10. The fuel injection arrangement 30 preferably has an injection nozzle or an injector.

The fuel mixing device 60 is fluidically connected to the LPG fuel reservoir 40 via a fuel pressure line 41 so that LPG fuel (i.e., liquid gas) can be supplied to the fuel mixing device 60.

Further, the fuel mixing device 60 is fluidically connected to the diesel fuel reservoir 50 via a fuel pressure line 51 so that diesel fuel can be supplied to the fuel mixing device 60.

The fuel mixing device 60 is constructed to produce a homogeneous fuel emulsion of LPG fuel and diesel fuel while maintaining the pressure required for the liquid aggregate state of the butane-propane gas mixture.

The fuel mixing device 60 is fluidically connected to the high-pressure fuel pump 70 via a fuel pressure line 61, and the high-pressure fuel pump 70 is fluidically connected to the fuel injection arrangement 30 by a fuel pressure line 71. The fuel injection arrangement 30 is constructed to inject the fuel emulsion provided by the fuel mixing device 60 into the at least one cylinder 10.

According to an embodiment of the invention, to produce the homogeneous fuel emulsion, the fuel mixing device 60 is constructed to mix into an LPG fuel volume flow whose magnitude is dependent upon an operating condition of the internal combustion reciprocating piston engine 1 a diesel fuel volume flow whose magnitude is smaller in relation to that of the LPG fuel volume flow. This is preferably carried out in such a way that the magnitude of the diesel fuel volume flow is less than 25 percent of the magnitude of the LPG fuel volume flow.

According to a further embodiment of the invention, the fuel mixing device 60 is so constructed that the magnitude of the diesel fuel volume flow is in a range of 1 to 15 percent, particularly in a range of 5 to 10 percent, of the magnitude of the LPG fuel volume flow.

The fuel mixing device 60 is preferably constructed such that it varies the magnitude of the diesel fuel volume flow in proportion to the magnitude of the LPG fuel volume flow depending on the operating condition (e.g., a load condition) of the internal combustion reciprocating piston engine 1 in order to ensure a combustibility of the fuel emulsion sufficient for the respective operating condition with a minimum proportion of diesel fuel in the fuel emulsion.

According to an embodiment of the invention, the internal combustion reciprocating piston engine 1 is constructed as a large-capacity four-stroke engine such as is used, e.g., for power plant applications and ship's propulsion applications. Alternatively, the internal combustion reciprocating piston engine 1 can also be constructed as a large-capacity two-stroke engine.

A method according to the invention for operating the internal combustion reciprocating piston engine 1 comprises at least the following steps: providing combustion air and compressing this combustion air in the cylinder 10, and injecting diesel fuel and LPG fuel by means of the fuel injection arrangement 30 into the compressed combustion air in the cylinder 10, and prior to the injection of diesel fuel and LPG fuel the diesel fuel is mixed with the LPG fuel by means of the fuel mixing device 60 so that the homogeneous fuel emulsion of LPG fuel and diesel fuel is produced, and the fuel emulsion is subsequently injected into the at least one cylinder 10.

According to an embodiment of the invention, the homogeneous fuel emulsion is produced by mixing into an LPG fuel volume flow whose magnitude is dependent upon the operating condition of the internal combustion reciprocating piston engine 1 a diesel fuel volume flow whose magnitude is smaller in relation to that of the LPG fuel volume flow.

According to a further embodiment of the invention, the homogeneous fuel emulsion is produced in such a way that the magnitude of the diesel fuel volume flow is less than 25 percent of the magnitude of the LPG fuel volume flow. The magnitude of the diesel fuel volume flow is preferably in a range of 1 to 15 percent, particularly in a range of 5 to 10 percent, of the magnitude of the LPG fuel volume flow.

The magnitude of the diesel fuel volume flow is preferably varied in proportion to the magnitude of the LPG fuel volume flow depending on the operating condition (e.g., the load condition) of the internal combustion reciprocating piston engine 1 in order to ensure a combustibility of the fuel emulsion sufficient for the respective operating condition with a minimum proportion of diesel fuel in the fuel emulsion.

To the person skilled in the art, it is clear from the foregoing description of the invention that the principles of the invention can also be applied without restriction to an internal combustion reciprocating piston engine which works according to the Diesel process and which has a plurality of cylinders and to a corresponding method of operation. In this case, each cylinder can be provided with its own fuel mixing device or an individual fuel mixing device can be provided for all cylinders collectively.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An internal combustion reciprocating piston engine for supplying drive energy using the Diesel process, comprising:
at least one cylinder (10);
a reciprocating piston (12) within said cylinder connected to a crankshaft (11);
an air supply device (21) for providing combustion air to be compressed by said reciprocating piston (12) in said cylinder (10); an LPG fuel reservoir (40) and a diesel fuel reservoir (50);
a fuel injection arrangement (30) for injecting into compressed combustion air within said cylinder (10) an LPG fuel from an LPG fuel reservoir (40) and a diesel fuel from a diesel fuel reservoir (50);
a fuel mixing device (60) fluidically connected to said LPG fuel reservoir (40) and to said diesel fuel reservoir (50), said fuel mixing device constructed to produce a homogeneous fuel emulsion from the LPG fuel and the diesel fuel; and wherein said fuel injection arrangement (30) is fluidically connected to said fuel mixing device (60) and constructed to inject the fuel emulsion into said at least one cylinder (10).

12. The internal combustion reciprocating piston engine according to claim 11, wherein, in order to produce the homogeneous fuel emulsion, the fuel mixing device (60) is constructed to mix into an LPG fuel volume flow whose magnitude is dependent upon an operating condition of the internal combustion reciprocating piston engine a diesel fuel volume flow whose magnitude is smaller in relation to that of the LPG fuel volume flow.

13. The internal combustion reciprocating piston engine according to claim 12, wherein said fuel mixing device (60) is constructed such that the magnitude of the diesel fuel volume flow is less than 25 percent of the magnitude of the LPG fuel volume flow.

14. The internal combustion reciprocating piston engine according to claim 12, wherein said fuel mixing device (60) is constructed such that the magnitude of the diesel fuel volume flow is in a range of 1 to 15 percent of the magnitude of the LPG fuel volume flow.

15. The internal combustion reciprocating piston engine according to claim 12, wherein the fuel mixing device (60) is constructed such that the magnitude of the diesel fuel volume flow is in a range of 5 to 10 percent of the magnitude of the LPG fuel volume flow.

16. The internal combustion reciprocating piston engine according to claim 11, wherein the internal combustion reciprocating piston engine is constructed as a large-capacity four-stroke engine.

17. A method of operating an internal combustion reciprocating piston engine working according to the Diesel process which has at least one cylinder in which is arranged a reciprocating piston connected to a crankshaft, an air supply device for providing combustion air in the cylinder, and a fuel injection arrangement for injecting an LPG fuel from an LPG fuel reservoir and a diesel fuel from a diesel fuel reservoir, said method comprising:
providing combustion air and compressing the combustion air in the cylinder;
mixing the diesel fuel with the LPG fuel by means of a fuel mixing device so that a homogeneous fuel emulsion of LPG fuel and diesel fuel is produced; and
subsequently injecting the fuel emulsion into the compressed combustion air within the at least one cylinder.

18. The method according to claim 17, wherein the homogeneous fuel emulsion is produced by mixing into an LPG fuel volume flow whose magnitude is dependent upon an operating condition of the internal combustion reciprocating piston engine a diesel fuel volume flow whose magnitude is smaller in relation to that of the LPG fuel volume flow.

19. The method according to claim 18, wherein the homogeneous fuel emulsion is produced in such a way that the magnitude of the diesel fuel volume flow is less than 25 percent of the magnitude of the LPG fuel volume flow.

20. The method according to claim 18, wherein the homogeneous fuel emulsion is produced in such a way that the magnitude of the diesel fuel volume flow is in a range of 1 to 15 percent, of the magnitude of the LPG fuel volume flow.

21. The method according to claim 18, wherein the homogeneous fuel emulsion is produced in such a way that the magnitude of the diesel fuel volume flow is in a range of 5 to 10 percent, of the magnitude of the LPG fuel volume flow.
